(19) United States
(12) Patent Application Publication
(10) Pub. No.: US 2023/0150212 A1
(43) Pub. Date: May 18, 2023

(54) METHOD FOR CONTROL OF SEMI-CRYSTALLINE THERMOPLASTIC MELT FRONT IN OUT OF AUTOCLAVE PROCESSING

(71) Applicant: Spirit AeroSystems, Inc., Wichita, KS (US)

(72) Inventor: Mark Anthony Wadsworth, Wichita, KS (US)

(73) Assignee: Spirit AeroSystems, Inc., Wichita, KS (US)

(21) Appl. No.: 17/982,653

(22) Filed: Nov. 8, 2022

Related U.S. Application Data
(60) Provisional application No. 63/278,907, filed on Nov. 12, 2021.

(51) Int. Cl. B29C 70/44

(52) U.S. Cl. CPC B29C 70/443; B29K 2101/12

(57) ABSTRACT

A system and method for thermoplastic composite processing including compressing and heating a thermoplastic composite panel having a plurality of terminal edges. The method further includes heating the thermoplastic composite panel to a melting temperature to create a melt front of the thermoplastic composite panel at a first location and heating the thermoplastic composite panel to the melting temperature in a pre-determined pattern from the first location toward the terminal edges of the thermoplastic composite panel. Extending the melt front toward the terminal edges in this way causes air constrained within the thermoplastic composite panel to escape the thermoplastic composite panel through unmelted portions of the thermoplastic composite panel located between the melt front and the terminal edges. Cooling of the panel may be similarly conducted, cooling a first region and then gradually continuing to cool the panel in a direction toward one or more of the terminal edges.

### RELATED ART

This is a non-provisional patent application claiming priority benefit to U.S. provisional patent application No. 63/278,907, entitled “Method for Control of Semi-Crystalline Thermoplastic Melt Front to Facilitate Low Porosity Consolidation in Out of Autoclave Processing,” filed Nov. 12, 2021 and incorporated by reference herein in its entirety.

### BACKGROUND

Thermoplastic composite components are used in aircrafts and other components requiring a combination of structural strength and heat resistance. Thermoplastic composite components can include thermoplastic composite laminates formed using heat and consolidating pressure. In out-of-autoclave (OoA) processing, for example, the laminate to be cured is enclosed within a vacuum bag enclosure and subjected to vacuum pressure only (no autoclave pressure). Then the laminate is heated without using an autoclave. This manner of processing is also referred to as vacuum-bag-only (VBO) processing. The vacuum bagging scheme in this method is used to generate an external pressure to the composite panels during cure.

Thermoplastic composite components, upon reaching a certain size and thickness, have porosity concentrated in a central region of the part after out-of-autoclave (OoA) consolidation. Typical porosity in a central region of a panel is depicted in FIG. 1, for example, which is undesirable in a thermoplastic composite component and results in an inferior part.

Thus, thermoplastic composite structural elements used in aircrafts are generally small in size (such as clips) and/or consolidated by autoclave or stamp forming. However, these thermoplastic composites are poor replacements for other thermoset materials used in aerospace, because they do not yield aerospace quality parts due to the porosity in the central region of the part after OoA consolidation.

Thus, these and other disadvantages of traditional OoA consolidation of thermoplastic composite components limit its practical application in aerospace and other such environments.

### SUMMARY

In some embodiments, a method of thermoplastic composite processing includes compressing a thermoplastic composite panel and heating the thermoplastic composite panel. The thermoplastic composite panel includes a plurality of terminal edges. The method further includes heating the thermoplastic composite panel to at least a melting temperature to create a melt front of the thermoplastic composite panel at a first location and heating the thermoplastic composite panel to at least the melting temperature in a pre-determined pattern from the first location toward the terminal edges of the thermoplastic composite panel. Specifically, the method can include heating in the pre-determined pattern from the first location to extend the melt front toward the terminal edges of the thermoplastic composite panel, thereby causing air constrained within the thermoplastic composite panel to escape the thermoplastic composite panel through unmelted portions of the thermoplastic composite panel located between the melt front and the terminal edges.

In another embodiment, a method of thermoplastic composite processing includes compressing the thermoplastic composite panel and heating the thermoplastic composite panel to at least a melting temperature using at least one heat source to create a melt front of the thermoplastic composite panel at a first location. Furthermore, the method includes heating the thermoplastic composite panel to at least the melting temperature in a pre-determined pattern from the first location to extend the melt front toward the terminal edges of the thermoplastic composite panel to cause air constrained within the thermoplastic composite panel to escape the thermoplastic composite panel through unmelted portions of the thermoplastic composite panel located between the melt front and the terminal edges.

In yet another embodiment, a method of thermoplastic composite processing can include the steps of compressing a thermoplastic composite panel, and heating the thermoplastic composite panel to at least a melting temperature to create a melt front of the thermoplastic composite panel at a first location. Furthermore, the method can include a step of heating the thermoplastic composite panel to at least the melting temperature in a pre-determined pattern from the first location to extend the melt front toward the terminal edges of the thermoplastic composite panel to cause air constrained within the thermoplastic composite panel to escape the thermoplastic composite panel through unmelted portions of the thermoplastic composite panel located between the melt front and the terminal edges. Then, the method can include a step of cooling the thermoplastic composite panel to a temperature below the melting temperature after an entirety of the thermoplastic composite panel has been heated to at least the melting temperature.

This summary is intended to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in more detail below with reference to the attached drawing figures, wherein:

FIG. 1 is a C-scan image of a prior art thermoplastic composite panel with porosity in a center region thereof;

FIG. 2 is a schematic cross-sectional side view of a system for heating and consolidating a thermoplastic composite panel in accordance with embodiments of the present invention;

FIG. 3 is a schematic top view of a heating device that heats thermoplastic composite panels from a center region outward, in accordance with embodiments of the present invention;

FIG. 4 is a schematic top view of a heating device that heats thermoplastic composite panels from a first end to a second end, in accordance with embodiments of the present invention; and

FIG. 5 is a table depicting an exemplary embodiment of timing, sequence, and temperature applied to various segments of the heating device depicted in FIG. 3, in accordance with embodiments of the present invention;

FIG. 6 is a flow chart of a method for manufacturing a thermoplastic composite panel in accordance with embodiments of the present invention;

FIG. 7 is a schematic cross-sectional side view of an alternative method for heating different regions by different amounts using varying thicknesses of insulation, in accordance with embodiments of the present invention; and

FIG. 8 is a flow chart of a method for manufacturing a thermoplastic composite panel in accordance with an alternative embodiment of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the present technology can include a variety of combinations and/or integrations of the embodiments described herein.

In order for thermoplastic composites to be a replacement for thermoset materials, an out-of-autoclave (OoA)/vacuum-bag-only (VBO) consolidation method yielding aerospace quality parts is needed. Multiple improvements to the bagging process and consolidation recipe can help reduce or eliminate porosity generally concentrated in the central region of the part after OoA consolidation. Bagging process improvements can include the use of undersized cauls, the use of edge dams with full size and oversized cauls all in an effort to prevent the vacuum bag from bridging at the panel edge leading to premature pinching off of breathing pathways for the panel.

The consolidation method for VBO can be modified compared to the standard autoclave cycle to include a low temperature dwell (e.g., about 550° F.), to have longer dwell times at the final processing temperature, and an increase in the final, above-melt processing temperature (e.g., increase from about 690° F. to about 716° F.). The low temperature dwell can be selected to be as hot as possible without causing melting. The low temperature dwell can provide time for moisture to be removed and can encourage volatilization of any non-polymer matrix materials such as solvents or surfactants prior to melting. Problematically, upon melting, the breathing pathways of the part collapse and any volatiles are trapped and appear as porosity upon consolidation.

Thus, a method is disclosed herein for heating from a center region out or from one end to an opposite end of a thermoplastic composite panel or part to eliminate trapped porosity. For example, as the central most region of the part is heated to above the melt temperature, in the liquid phase, dissolved gas and trapped gas liberated from the reinforcement has high concentration and therefore will move to regions of lower concentration (i.e., the unmelted portion of the part still subjected to vacuum). Furthermore since the unmelted laminate still has open, albeit tortuous, planar pathways between plies the gas can also flow to the edge due to a slight pressure differential as well as due to the aforementioned Brownian motion.

Therefore, systems and methods herein are suitable for thermoplastic composite processing and in particular compressing and heating a thermoplastic composite panel (e.g., laminate), having one or more terminal edges. The heating of the thermoplastic composite panel involves heating to at least a melting temperature, creating a melt front at a first location, then continuing this heating in a predetermined pattern extending the melt front from the first location toward the terminal edges. This causes air constrained within the thermoplastic composite panel to escape the thermoplastic composite panel through unmelted portions of the thermoplastic composite panel located between the melt front and the terminal edges.

For example, the first location can be in a center region or center location of the thermoplastic composite panel that is melted first and then the melt front can be gradually applied across the thermoplastic composite panel in an outward, starburst shape, and/or radial manner originating in the center region and terminating at the terminal edges of the thermoplastic composite panel. Specifically, the pre-determined pattern can be a starburst pattern, with the first location of the thermoplastic composite panel heated to at least the melting temperature to create the melt front, whereafter at least a first zone immediately adjacent to and completely surrounding the first location is subsequently heated to the melt temperature such that the melt front moves radially outward from the first location toward the terminal edges of the thermoplastic composite panel. Then subsequent to the first location and the first zone being heated to at least the melting temperature, a second zone immediately adjacent to and completely surrounding the first zone is subsequently heated to the melt temperature such that the melt front moves radially outward from the first location and the first zone toward the terminal edges of the thermoplastic composite panel.

A “center region” as used herein may be, but is not necessarily required to be, located in a precise center of the thermoplastic composite panel. Rather, in some embodiments, the “center region” can refer to any first region located inward of various other regions and inward of all terminal edges of the thermoplastic composite panel. That is, the “center region” and/or the “central location” can either be the geometric center of the panel or can be generally a location spaced inwardly from each of the edges of the thermoplastic composite panel. Likewise, locations indicated herein as being at or adjacent to the terminal edges can either be at the terminal edge or just inward therefrom (which, when melting adjacent to the terminal edge causes the gas to escape to the terminal edge through an unmelted portion of the thermoplastic composite panel, which may be advantageous for allowing the gas to pass through unmelted portions as the first location is melted). The term “pre-determined pattern” as used herein can mean any pattern that begins at one location and extends therefrom such that only a portion of the thermoplastic composite panel is heated until the pattern is completed, at which point the entire thermoplastic composite panel is heated to a melt temperature or above the melt temperature of the thermoplastic in the thermoplastic composite panel. It should also be understood by one having ordinary skill in the art that the term ‘pre-determined pattern’ does not include uniform heating of the entire thermoplastic composite panel simultaneously to or above the melting temperature thereof.

In one alternative embodiment, the first location is at the center region or the center location and the pre-determined pattern is applied in a spiral pattern. For example, the spiral pattern can begin in the center region or center location, and endi at one or more of the terminal edges of the thermoplastic composite panel. Specifically, the first location of the thermoplastic composite panel is heated to at least the melting temperature to create the melt front, whereafter zones of the thermoplastic composite panel extending radially outward and in a simultaneous circular manner are subsequently and sequentially heated to at least the melting temperature to cause the melt front to expand in an outward radial manner to cause the air to migrate radially outward from the first location toward at least one of the terminal edges.

In yet another embodiment, the first location is at or adjacent to at least one of the terminal edges of the thermoplastic panel (e.g., the first location can be a portion of an entire length of at least one of the terminal edges of the thermoplastic composite panel). In this embodiment, the pre-determined pattern begins at the first location (e.g., at one of the terminal edges of the thermoplastic composite panel), then gradually continues across the thermoplastic composite panel, concluding this melting at a second region terminating at another one of the terminal edges, such as an opposite edge of the thermoplastic composite panel. The pre-determined pattern in this embodiment can be linear, sinusoidal, zig-zag, or any pattern moving from one of the terminal edges to another of the terminal edges. For example, the pre-determine pattern can be a linear pattern, and the first location of the thermoplastic composite panel can be heated to at least the melting temperature to create the melt front, whereafter the portions of the thermoplastic composite panel immediately adjacent to the first location are heated to at least the melting temperature to cause the melt front to move linearly toward the terminal edge opposite the first location until the melt front reaches the terminal edge opposite the first location.

In yet another embodiment, the first location can extend an entire length between two non-adjacent terminal edges of the thermoplastic composite panel. For example, heating the first location can include heating a line across an entire center of the thermoplastic composite panel (such as an entire height or an entire width of the thermoplastic composite panel), such that the melt front can begin along that line and can move in opposite lateral directions from the first location toward opposing lateral edges simultaneously.

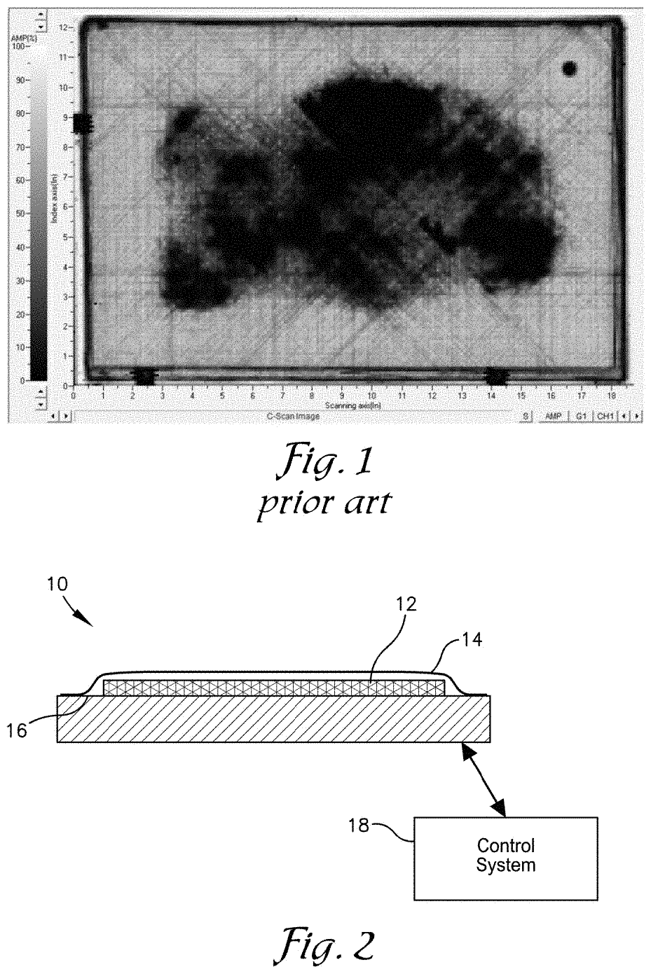

In each of these pre-determined patterns described herein, trapping porosity in a center region as in prior art methods (e.g., see FIG. 1) is avoided. Rather, by melting from the center region out (e.g., in a starburst or spiral pattern) or from one terminal edge across the thermoplastic composite panel to another, there is always a high permeability pathway for trapped or generated gases to escape, and a melt front propagating outwards or from one end to an opposite end encourages any dissolved gas to diffuse towards the air pathways left in unmelted regions thereby reducing the amount of trapped gases as opposed to just compressing the volume of trapped gas as in press or autoclave consolidations. It should be understood by one having ordinary skill in the art that the thermoplastic composite panel in the above systems and methods can be formed as semi-crystalline or amorphous.

As depicted in FIG. 2, a system 10 for performing the methods described herein comprises a thermoplastic composite panel 12, a vacuum bag 14, and a heat source 16. Furthermore, in some embodiments, the heat source 16 can be controlled by a control system 18 configured for instructing locations on the thermoplastic composite panel 10 to be heated and in which order, as described in more detail below.

The thermoplastic composite panel 12 can have a plurality of terminal edges and comprises one or more thermoplastic composite plies (e.g., semi-crystalline or amorphous thermoplastic composite plies) stacked together to form an uncured panel which then is heated and consolidated to form a final thermoplastic composite panel or part. In some embodiments, the thermoplastic composite panel comprises a reinforcement fiber and a thermoplastic matrix resin. For example, the thermoplastic matrix resin can be one or more of: polyaryletherketone (PAEK), polyetherketoneketone (PEKK), polyetheretherketone (PEEK), polyphenylene sulfide (PPS), Polyethylenimine (PEI), and the like. The matrix resin of the thermoplastic composite panel can be semi-crystalline or amorphous upon cooling in accordance with one or more of the method steps later described herein. The thermoplastic composite panel 12 can be planar or non-planar (e.g., having a contoured profile) and have any size, shape, and/or number of terminal edges.

The vacuum bag may be any flexible, impermeable membrane configured for sealing around the thermoplastic composite panel and actuated to compress the thermoplastic composite panel or the plies thereof via a pressure differential (e.g., pulling vacuum via a port formed through the vacuum bag). For example, compressing a thermoplastic composite panel can include surrounding the thermoplastic composite panel with a bag (e.g., the vacuum bag 14) and reducing pressure within the bag via vacuum, autoclave, and/or the like. Other methods of introducing a pressure differential to compress the vacuum bag for consolidation of the thermoplastic composite panel known in the art can be used without departing from the scope of the technology described herein.

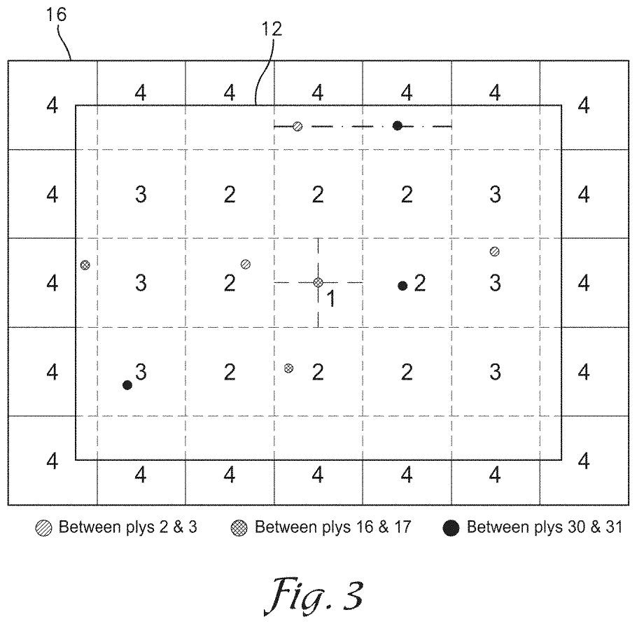

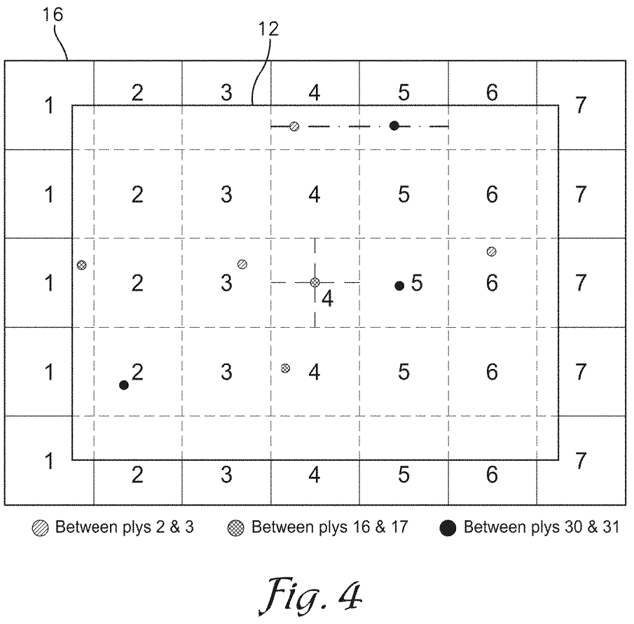

The heat source can be a heat plate, an oven, a handheld manual heat source moved in a predetermined melt pattern by an operator or a robotic arm (not shown), or other sources of heat controllable for thermoplastic composite heating known in the art. The heat source can generate and provide at least one of radiant, convection, resistance, induction, or other similar types of heat that are suitable for heating the thermoplastic composite panel. The heat source is capable of heating the thermoplastic composite panel in a pre-determined pattern such as a sunburst pattern (FIG. 3), a lateral-linear pattern (FIG. 4), a spiral pattern (not shown) or any other pattern that heats portions of the panel in a sequential manner configured to cause dissolved gas within a central region of the panel to migrate toward and escape from one or more of the terminal edges of the panel. In some embodiments, the heat source is configured to provide uniform heat across the entire thermoplastic composite panel as well as provide heat in a pre-determined pattern. For example, a multi-segment heating element or heat plate, as depicted in FIG. 3, can have a plurality of different heat segments or zones (e.g., each 4″×4″ individually temperature-controlled element on a pixelated heating tool) that are heated up in a pre-determined or pre-programmed order and/or temperature in order to heat the thermoplastic composite panel in the patterns described herein. For example, as depicted in FIG. 3, sections of the heat plate labeled 1 can be a first heat zone turned on first or heated to a melt temperature first, then sections of the heat plate labeled 2 can be a second heat zone turned on or heated to a melt temperature next, followed by sections labeled 3 (e.g., a third zone) then sections labeled 4 (e.g., a fourth zone). However, in another embodiment, the heat plate can have plates or sections activated in different patterns, such as from a first edge to a second edge, as depicted in FIG. 4. For example, as in FIG. 4, the first section can be turned on first and then the second, third, fourth, fifth, sixth, then seventh sections can be turned on in a progressive pattern at pre-determined time intervals.

The control system for controlling the heat source can comprise a processor, circuitry, and/or memory devices configured for instructing the heat source to either move in a pre-determined pattern and/or otherwise heat up different portions of the thermoplastic composite panel in a particular order/pattern. For example, the control system can instruct the heat source regarding which sections of the heat plate to turn on, when, for how long, and at what temperature. Alternatively, the control system can instruct the robotic arm to move the heat source in a predetermined pattern relative to the thermoplastic composite panel.

The control system, constructed in accordance with various embodiments of the current invention, can be embodied by any one or more electronic devices such as computer servers, workstation computers, desktop computers, laptop computers, palmtop computers, notebook computers, tablets or tablet computers, smartphones, mobile phones, cellular phones, or the like. Additionally or alternatively, the control system can include basic circuitry configured to perform simple procedures such as turning on and/or turning off of one or more of the sections of the heat plate. Additionally or alternatively, the control system can also include basic circuitry configured to perform simple procedures such as adjusting each section of the heat plate to a pre-determined temperature at a pre-determined time, or otherwise adjust the temperature of a movable heat source. In some embodiments, the control system broadly comprises a memory element and a processing element communicably and/or electrically coupled to the heat source, a robotic implement or robotic actuators of the heat source, and/or subsections of the heat source such as the heat plate sections described above.

The memory element may be embodied by devices or components that store data in general, and digital or binary data in particular, and may include exemplary electronic hardware data storage devices or components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, solid state memory, or the like, or combinations thereof. In some embodiments, the memory element may be embedded in, or packaged in the same package as, the processing element. The memory element may include, or may constitute, a non-transitory “computer-readable medium”. The memory element may store the instructions, code, code statements, code segments, software, firmware, programs, applications, apps, services, daemons, or the like that are executed by the processing element. The memory element may also store data that is received by the processing element or the device in which the processing element is implemented. The memory element may further store data such as user-programmed data and/or historical records associated with the system 10. In addition, the memory element may store settings, data, documents, databases, and variables (e.g., temperature, start times, durations at a given temperature, end times, and the like).

The processing element may comprise one or more processors. The processing element may include electronic hardware components such as microprocessors (single-core or multi-core), microcontrollers, digital signal processors (DSPs), field-programmable gate arrays (FPGAs), analog and/or digital application-specific integrated circuits (ASICs), or the like, or combinations thereof. The processing element may generally execute, process, or run instructions, code, code segments, code statements, software, firmware, programs, applications, apps, processes, services, daemons, or the like, such as one or more the method steps described herein. The processing element may also include hardware components such as registers, finite-state machines, sequential and combinational logic, configurable logic blocks, and other electronic circuits that can perform the functions necessary for the operation of the current invention. In certain embodiments, the processing element may include multiple computational components and functional blocks that are packaged separately but function as a single unit. In some embodiments, the processing element may further include multiprocessor architectures, parallel processor architectures, processor clusters, and the like, which provide high performance computing. The processing element may be in electronic communication with other electronic components (e.g., the heat source) through serial or parallel links that include universal busses, address busses, data busses, control lines, and the like.

The processing element may be operable, configured, or programmed to perform the following functions by utilizing hardware, software, firmware, or combinations thereof, as disclosed below. For example, in use, the processing element may be configured to turn on and off various portions of the heat plate described herein for a predetermined time, at a predetermined temperature, and in a predetermined sequence. The time, temperature, and sequence can be adjusted by user input or in accordance with a selection of preprogrammed instructions. Alternatively, the processing element may be configured to move or actuate a robotic implement or robotic actuator in one or more predetermined patterns and/or at one or more predetermined temperatures. In yet another alternative embodiment, the processing element instructs heating and/or opening and closing heating dies onto the thermoplastic composite panel as described herein. The processing element may also provide heating and/or actuation instructions for any of the other heating systems described herein for heating the thermoplastic composite panel in a pre-determined pattern, such as: controlled infrared heating, torching or hot air blasts, induction coils having varying amounts of magnetic field strength in different regions, or the like.

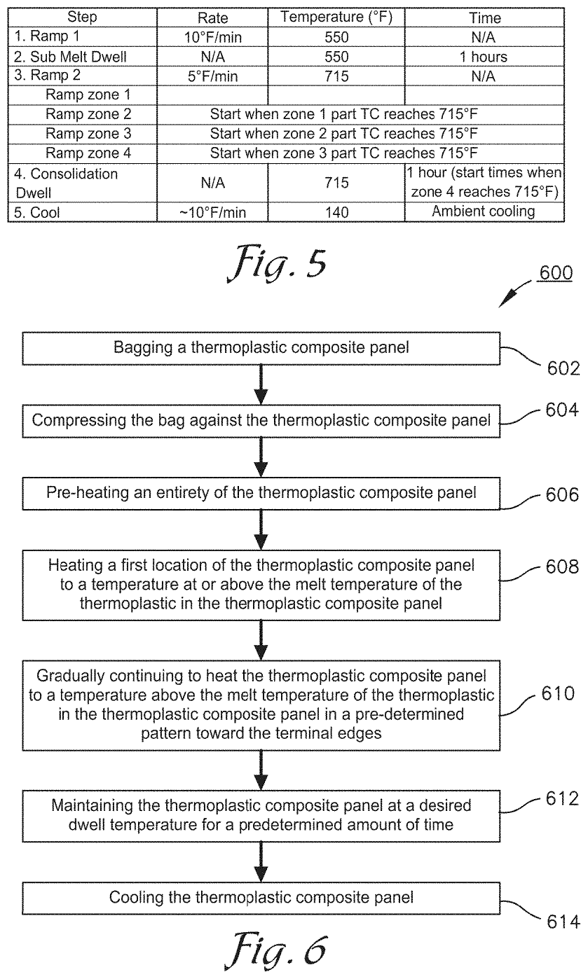

One example method of consolidating and heating a thermoplastic composite panel in a pre-determined pattern, wherein the pre-determined pattern heats the thermoplastic panel from a center or central region outwardly using the heat plate in FIG. 3 and controlled in the manner depicted in a table in FIG. 5. The method of consolidating and heating a thermoplastic composite panel includes a ramp step during which the temperature is ramped up at 10° F./min until reaching about 550° F. with full vacuum applied via the vacuum bag. Once the part reaches this desired temperature it may be followed by sub melt dwell time of about 1 hour at 550° F. with vacuum maintained at at least 27″ Hg. Next, each zone beginning with zone 1 of the heat plate is gradually increased to a melt temperature. Specifically, zone 1 is ramped up at 5° F./min to 715° F. Once zone 1 reaches 715° F., zone 2 begins to be heated. Furthermore, when zone 2 reaches 715° F., zone 3 begins to be heated. Likewise, when zone 3 reaches 715° F., zone 4 begins to be heated. The table in FIG. 5 further indicates that the heat plate remains at 715° F. for one hour once zone 4 reaches 715° F. Finally, the table in FIG. 5 depicts a rate at which the heat plate may be cooled via ambient cooling or the like. This cooling may continue until the temperature of heat plate has decreased to approximately 140° F., as indicated in the exemplary embodiment in FIG. 5. The method and steps described above relate to the consolidation of a PAEK thermoplastic composite panel, and it should be understood by one having ordinary skill in the art that the temperatures should be adjusted accordingly for utilizing the above method and steps for the consolidation of thermoplastic composite panels being formed of material(s) other than PAEK. Other example thermoplastics that can be used for the thermoplastic composite panel 12 described herein can include one or more of the following: polyetherketoneketone (PEKK), polyetheretherketone (PEEK), polyphenylene sulfide (PPS), Polyethylenimine (PEI), and the like.

FIG. 6 depicts a listing of at least a portion of the steps of an exemplary method 600 for processing a thermoplastic composite panel using heat and consolidation force. The steps may be performed in the order shown in FIG. 6, or they may be performed in a different order or even simultaneously. Furthermore, some steps may be performed concurrently as opposed to sequentially. In addition, some steps may be optional or may not be performed. The steps may be performed by the control system 18 via hardware, software, firmware, or combinations thereof and/or by a user or operator of various components of the system 10 described herein. Furthermore, the steps may be implemented as instructions, code, code segments, code statements, a program, an application, an app, a process, a service, a daemon, or the like, and may be stored on a computer-readable storage medium, such as the memory element.

Prior to the method of thermoplastic composite processing described below, layers of plies forming a thermoplastic composite panel can be strategically tacked together to maintain desired orientations and/or placements of each layer relative to each other. For example, specific tacking locations between specific plies is depicted and described in FIGS. 3 and 4. In these example embodiments, tacking is applied between a second ply and a third ply in at least two different spaced-apart locations, tacking is applied between a sixteenth ply and a seventeenth ply in at least two different spaced-apart locations, and tacking is applied between a thirtieth ply and a thirty-first ply in at least two different spaced-apart locations. When tacked together, the plies are less likely to shift out of a desired orientation or position during the processing steps described herein. However, other tacking methods and locations can be used or no tacking can be used without departing from the scope of the technology described herein.

In some embodiments, the method 600 of thermoplastic composite processing includes bagging a thermoplastic composite panel, as depicted in block 602, and compressing the bag against the thermoplastic composite panel, as depicted in block 604. This compressing can be performed via introduction of a pressure differential, such as via pulling vacuum via a vacuum port. However, other methods of compressing the plies together can be employed without departing from the scope of the technology described herein and may or may not require bagging of the thermoplastic composite panel.

In some embodiments, method 600 includes a step of pre-heating an entirety of the thermoplastic composite panel to a temperature just below the thermoplastic composite panel's melting temperature, as shown in block 606. In step 606, the thermoplastic composite panel should be raised to as high a temperature as possible without softening to the point where the plies seal together, preventing volatile escape paths. In some example embodiments, the temperature to which the thermoplastic composite panel is heated in step 606 is between about one percent to about twelve percent below the thermoplastic composite panel's melting temperature. In other embodiments, the temperature to which the thermoplastic composite panel is heated in step 606 is between about five percent to about ten percent below the melting temperature of the composite panel. In further embodiments, the temperature to which the thermoplastic composite panel is heated in step 606 is between about seven percent to about ten percent below the melting temperature of the composite panel. In still further embodiments, the temperature to which the thermoplastic composite panel is heated in step 606 is between about one percent to about five percent below the melting temperature of the composite panel. It should be understood by one having ordinary skill in the art that the temperature to which the thermoplastic composite panel is heated in step 606 is dependent upon the materials used for the thermoplastic composite panel but the temperature should be lower than the melting temperature of the thermoplastic composite panel without softening the material to the point where the plies seal together, which can close or otherwise eliminate some, most, or all of the volatile escape paths. In some embodiments of the method 600, this pre-heating step can be omitted without departing from the scope of the invention.

The method 600 further comprises heating a first location of the thermoplastic composite panel to a temperature at or above the melt temperature of the thermoplastic in the thermoplastic composite panel, as depicted in block 608. For example, as described herein, this step can include heating the thermoplastic composite panel in a center region of the thermoplastic composite panel first, or alternatively, heating the thermoplastic composite panel at a first end region.

The method 600 also comprises gradually continuing to heat the thermoplastic composite panel to a temperature above the melt temperature of the thermoplastic in the thermoplastic composite panel in a pre-determined pattern toward the terminal edges, as depicted in block 610. The temperature at or above the melt temperature can also be referred to herein as the “dwell temperature.” The thermoplastic composite panel is heated in the pre-determined pattern until the temperature of the entire panel is at or above the melting temperature or is at the dwell temperature that is above the melting temperature. For example, in embodiments where the pattern of this heating step originates in the center region, successive segments or sections of the thermoplastic composite panel are progressively heated, terminating at outer edges (i.e., the terminal edges) of the thermoplastic composite panel. For example, gradually continuing to heat the thermoplastic composite panel in the outward, radial, or spiral pattern can include heating regions outward of the center region to above the melt temperature of the thermoplastic composite panel. Alternatively, in embodiments where a spiral heat pattern is used, step 608 can begin in the center region and progressively apply heat in a spiral pattern until heating regions at one or more of the terminal edges of the thermoplastic composite panel. In yet another alternative embodiment, step 610 includes progressively applying heat to adjacent segments or sections of the thermoplastic composite panel from the first end region to a second end region opposite the first end region. The first and second end regions, for example, can be at opposing ones of the terminal edges of the thermoplastic composite panel.

In some embodiments, the step of gradually continuing to heat in the outward or radial pattern is performed by thermal conduction, with a melt front progressing through the thermoplastic composite panel in the radial direction originating in the center region and pushing out trapped volatiles from between layers of the thermoplastic composite panel. Regardless of which starting point and which heating pattern is applied to the thermoplastic composite panel, each embodiment, there is continuously a higher permeability pathway for volatiles or trapped or generated gases to escape. As the melt front translates along the pre-determined pattern, the movement of the melt front encourages any dissolved gas to diffuse towards the air pathways left in unmelted regions of the thermoplastic composite panel. This advantageously reduces the amount of trapped gases as opposed to merely compressing the volume of trapped gas as in press or autoclave consolidations.

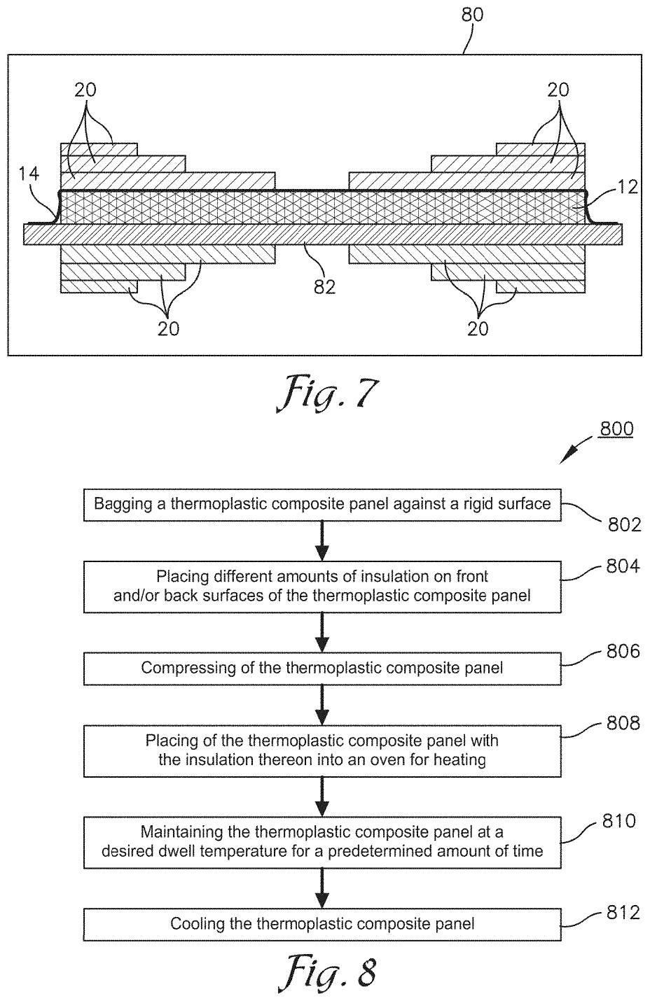

Steps 608 and 610 are performed, in some embodiments, simultaneous to the compressing step 604, such that compression occurs during the melting of the thermoplastic of the thermoplastic composite panel. Furthermore, steps 608 and 610 can be performed, in some embodiments, after placing the thermoplastic composite panel onto the heating element such as the heating plate in FIG. 3 with a plurality of individually-controlled heat zones, including a center zone and a next-to-center zone. In this embodiment, as described above and in the exemplary method of FIG. 5, the center zone is heated to a melt temperature of the thermoplastic composite panel first, then the next-to-center zone is heated to the melt temperature of the thermoplastic composite panel. However, other heating methods for accomplishing the predetermined heating patterns described herein can be used without departing from the scope of the method in FIG. 6. For example, an alternative heating method is described below and depicted in FIGS. 7 and 8.

The method 600 can further include maintaining the thermoplastic composite panel 12 at a desired dwell temperature for a predetermined amount of time, as depicted in block 612. In some embodiments, this may be a temperature suitable to melt the thermoplastic in the thermoplastic composite panel 12. However, other processing temperatures may be used as the desired dwell temperature without departing from the scope of the technology described herein. The method 600 can also include a step of cooling the thermoplastic composite panel 12, as shown in block 614. This step can be achieved by removal of the application of heat and/or utilizing ambient cooling. In other embodiments, the cooling step 614 can be accomplished by cooling the thermoplastic composite panel in a similar or identical pre-determined pattern as the heating patterns described above.

Specifically, in addition to controlled heating of the thermoplastic composite panel 12, other embodiments can additionally and/or alternatively use controlled cooling of the panel 12 following heating and/or curing thereof. For example, this controlled cooling can begin in middle or center regions of the thermoplastic composite panel 12 and then gradually proceed to cooling successive outer regions of the thermoplastic composite panel 12 until reaching one or more of the terminal edges thereof. This same process can alternatively proceed from a left to a right region, a top to a bottom region, or from one edge region to another edge region of the thermoplastic composite panel 12 in some embodiments. Additionally or alternatively, any of the pre-determined patterns used for heating the thermoplastic composite panel described herein can additionally or alternatively be used to for cooling of the thermoplastic composite panel 12.

This cooling can be performed similar to the heating or can be performed independent of the specific heating patterns described above. That is, after heating the thermoplastic composite panel during any curing process using any pattern or no pattern, this cooling can include the steps of: (a) cooling the thermoplastic composite panel in a first region of the thermoplastic composite panel first; and (b) then gradually continuing to cool the thermoplastic composite panel in a direction outward from the first region and terminating at one or more of the terminal edges of the thermoplastic composite panel. In one example embodiment, the first region is a center region of the thermoplastic composite panel, and the step of gradually continuing to cool the thermoplastic composite panel in a direction outward from the first region includes gradually continuing to cool the thermoplastic composite panel in a radial manner outward, originating in the center region and terminating at the one or more of the terminal edges. Alternatively, in another example embodiment, the first region is located at a first edge of the thermoplastic composite panel, and the step of gradually continuing to cool the thermoplastic composite panel in a direction outward from the first region includes gradually continuing to cool the thermoplastic composite panel in a first direction moving laterally across the thermoplastic composite panel toward a second region terminating at a second edge of the thermoplastic composite panel.

This gradual controlled cooling can advantageously assist in addressing residual stresses and/or warping introduced during the cooling. In some embodiments, this gradual controlled cooling described herein can assist in ensuring that plies of the thermoplastic composite panel 12 do not unduly shift relative to each other during this cooling step of the curing process. Note that cooling as described herein can refer to steps of turning down heaters in a middle region first and then turning down heaters in outer regions (such as the regions depicted in FIG. 3). Additionally or alternatively, cooling can include water mist or active cooling techniques applied from a center region outward as described herein or from one edge region, across the panel, to another edge region (or from one of the terminal edges to another one of the terminal edges).

Note that the heat propagation and the cooling propagation methods described herein can be utilized independently of each other or can be used as part of a single curing process. While the curing methods and heating and cooling steps described herein are described for use with OoA/VBO consolidation methods, the heating and cooling methods and patterns described herein can be used in other composite part curing processes without departing from the scope of the technology herein.

In some embodiments, as the temperature of the thermoplastic composite panel naturally adjusts to equalize through conduction, the regions of the thermoplastic composite panel outward of the central most region are kept cool so as to not melt or partially melt before the center section. The melt front may progress through the thermoplastic composite panel and provide the benefit of pushing out trapped volatiles. In some embodiments, thermal conduction, rather than the heated source, can cause melting in the outer portions of the thermoplastic composite panel.

Although the gradual heating and cooling of the thermoplastic composite panels in a pre-determined pattern described herein are depicted as being performed on a heat plate having individually-controlled heating elements, sections, or zones, it should be understood by one having ordinary skill in the art that other methods of heating in accordance to the patterns described herein can be used without departing from the scope of the technology described herein. This can include active or non-active control means (such as varying amounts of insulation).

In one alternative embodiment, as depicted in FIGS. 7 and 8, a method 800 includes a step of bagging the thermoplastic composite panel to a rigid surface, as depicted in block 802, and placing different amounts of an insulation 20 on front and/or back surfaces of the thermoplastic composite panel 12, as depicted in block 804. Specifically, little or no insulation may be placed at a first region (e.g., a center region of the panel) and additional insulation may be placed onto second and/or third regions (e.g., any of regions 2, 3, or 4 in FIG. 3). For example, as depicted in FIG. 7, the thermoplastic composite panel 12 can be placed on a rigid support 82 and then bagged with the vacuum bag 14 sealed to the rigid support 82, similar to earlier embodiments. Then the varying layers of insulation 20 can be added over and under the thermoplastic composite panel 12 (e.g., with insulation 20 placed over the vacuum bag 14 and under the rigid support 82 as depicted in FIG. 7). The method 800 also includes compressing of the thermoplastic composite panel 12, as depicted in block 806, via vacuum compression of the bagging material or some other compression techniques known in the art. Furthermore, the method includes a step of placing of the thermoplastic composite panel 12 with the insulation 20 thereon into an oven 80, as depicted in block 808 and illustrated in FIG. 7. This results in gradual heating from an inner region to an outer region, similar to other embodiments described above.

With little or no barrier between oven heating elements and the first region, heat quickly reaches the first region from the oven heating elements (e.g., heating elements placed above the insulation 20), but is impeded by the insulation from reaching the other portions covered by progressively thicker insulation as quickly. For example, if the insulation 20 is located only on a top side of the thermoplastic composite panel 12, heating elements can be located above that top side and the heat therefrom naturally heats the uninsulated portion first, followed by the thinly insulated portions and so on. Likewise, if the insulation 20 is located on both the top side and an opposing bottom side of the thermoplastic composite panel 12, as illustrated in FIG. 7, the heating elements (e.g., oven heating elements) can be located above and/or below the thermoplastic composite panel 12 (or the oven can be a convection oven) and the heat therefrom naturally heats the uninsulated portion first, followed by the thinly insulated portions and so on.

In some embodiments, the insulation 20 can be added to each successive region further outward from a center region of the thermoplastic composite panel 12 in quarter-inch increments, half-inch increments, or more. However, other amounts of insulation can be used to create a desired amount of gradual heating from a first region to a second region or a center region to an outer region of the thermoplastic composite panel during heating/curing thereof. The insulation 20 in FIG. 7 can be a continuous insulation component cut or formed with increased thickness at at least one of the terminal edges and/or can include additional layers of insulation at the terminal edges compared with regions closer to the center location of the thermoplastic composite panel 12.

The method 800 also includes maintaining the thermoplastic composite panel at a desired dwell temperature for a predetermined amount of time, as depicted in 810, and cooling the thermoplastic composite panel, as depicted in 812. Steps 810 and 812 can be similar to steps 612 and 614, respectively. Generally, in the embodiments depicted in FIGS. 7 and 8, the cooling will occur naturally once by removing the thermoplastic composite panel 12 and the insulation 20 thereon out of the oven 80. Although the method 800 is described above and depicted in FIG. 7 as applying the insulation 20 with less insulation or no insulation in a center, and gradually using thicker insulation closer and closer to an outer edge region (e.g., proximate one or more of the terminal edges), other patterns of insulation can be used to create the other predetermined heat patterns described herein. For example, less insulation or no insulation can be provided at a first region, more insulation can be provided at an adjacent region thereto, and more insulation still can be provided at a second region at an end of the thermoplastic composite panel 12 opposite of an end where the first region is located, thus allowing for a high permeability pathway (e.g., from one end to another end) for trapped or generated gases to escape. Regardless of which predetermined pattern described herein is used, the thicker the insulation, the longer it takes for a given region of the thermoplastic composite panel 12 to reach the melt temperature of the thermoplastic in the thermoplastic composite panel. Thus, the insulation pattern allows for a center region-out, spiral, and/or end-to-end heating pattern as described in other examples herein.

Other alternative methods of heating the thermoplastic composite panel in a pre-determined pattern as described herein can include manually and/or robotically moving or actuating a heating element, or heating dies (not shown) formed of different materials each having different heating characteristics, thereby progressively heating different segments or portions of the thermoplastic composite panel. For example, the heating steps for progressively-applying heat in the patterns described herein can include placing the thermoplastic composite panel into dies having different sections formed of different materials with different heating characteristics. In one embodiment, a first material of the dies contacting the center region is configured to reach a melting temperature of the thermoplastic composite panel faster than a second material of the dies contacting a region of the thermoplastic composite panel outward of the center region. Additionally or alternatively, these heating steps can be performed by controlled infrared heating, torching or hot air blasts applied manually in selective regions as described herein, or induction coils having varying amounts of magnetic field strength in different regions of the thermoplastic composite panel. Any method that results in heat propagation in a pre-determined pattern on the thermoplastic composite panel can be used.

Advantageously, residual gas is encouraged during the steps described herein to diffuse outside of the central most region of the thermoplastic composite panel. Further, with the elevated temperature of melting, any material that had not yet volatized at the low temperature dwell is volatilized and diffused to outside of the melted region. The progressive heating described therein can be repeated continuously in an outward moving fashion until the entire part is melted, or from one edge region to an opposing edge region. Subsequently, cooling of the part can happen in any manner or direction now that gases that cause porosity have been removed from the part. However, cooling patterns similar to the heating patterns described herein can additionally or alternatively be used as described above.

This method can advantageously allow for final VBO consolidation of thick and or large surface area components without a precursor step such as automated fiber placement (AFP). This can allow higher rate manufacture through use of pick and place or lightly tacked preforms. The result can be a potential elimination of AFP and/or autoclave, which represents a large capital expenditure cost savings.

Although the invention has been described with reference to example embodiments illustrated in the attached drawing figures, it is noted that equivalents may be employed and substitutions made herein without departing from the scope of the invention as described and claimed herein. Specifically, the example embodiments of the methods described above in FIGS. 6 and 8 are merely examples and are not intended to limit the scope of the invention.

1. A method of thermoplastic composite processing, the method comprising:
compressing a thermoplastic composite panel, wherein the thermoplastic composite panel includes a plurality of terminal edges;
heating the thermoplastic composite panel to at least a melting temperature to create a melt front of the thermoplastic composite panel at a first location; and
heating the thermoplastic composite panel to at least the melting temperature in a pre-determined pattern from the first location to extend the melt front toward the terminal edges of the thermoplastic composite panel to cause air constrained within the thermoplastic composite panel to escape the thermoplastic composite panel through unmelted portions of the thermoplastic composite panel located between the melt front and the terminal edges.

2. The method of claim 1, wherein compressing the thermoplastic composite panel includes: surrounding the thermoplastic composite panel with a bag and reducing a pressure within the bag.

3. The method of claim 1, further comprising cooling the thermoplastic composite panel, wherein the thermoplastic composite panel includes a matrix resin that is semi-crystalline or amorphous upon cooling.

4. The method of claim 1, wherein the first location is a central location of the thermoplastic composite panel.

5. The method of claim 1, wherein the first location is at or adjacent to a terminal edge of the thermoplastic composite panel.

6. The method of claim 5, wherein the first location extends an entire length between two non-adjacent terminal edges of the thermoplastic composite panel.

7. The method of claim 5, wherein the first location is a portion of an entire length of the terminal edge of the thermoplastic composite panel.

8. The method of claim 4, wherein the pre-determined pattern is a spiral pattern, wherein the first location of the thermoplastic composite panel is heated to at least the melting temperature to create the melt front, whereafter zones of the thermoplastic composite panel extending radially outward and in a simultaneous circular manner are subsequently and sequentially heated to at least the melting temperature to cause the melt front to expand in an outward radial manner to cause the air to migrate radially outward from the first location toward at least one terminal edge.

9. The method of claim 4, wherein the pre-determined pattern is a starburst pattern, wherein the first location of the thermoplastic composite panel is heated to at least the melting temperature to create the melt front, whereafter at least a first zone immediately adjacent to and completely surrounding the first location is subsequently heated to the melt temperature such that the melt front moves radially outward from the first location toward the terminal edges of the thermoplastic composite panel.

10. The method of claim 9, wherein subsequent to the first location and the first zone being heated to at least the melting temperature, a second zone immediately adjacent to and completely surrounding the first zone is subsequently heated to the melt temperature such that the melt front moves radially outward from the first location and the first zone toward the terminal edges of the thermoplastic composite panel.

11. The method of claim 5, wherein the pre-determine pattern is a linear pattern, wherein the first location of the thermoplastic composite panel is heated to at least the melting temperature to create the melt front, whereafter the portions of the thermoplastic composite panel immediately adjacent to the first location are heated to at least the melting temperature to cause the melt front to move linearly toward the terminal edge opposite the first location until the melt front reaches the terminal edge opposite the first location.

12. The method of claim 1 further comprising pre-heating the thermoplastic composite panel to a temperature above ambient temperature but below the melting temperature of the thermoplastic composite panel.

13. The method of claim 12, wherein pre-heating the thermoplastic composite panel includes heating the thermoplastic composite panel to a temperature between about one to twelve percent (1-12%) below the melting temperature.

14. The method of claim 1, further comprising placing the thermoplastic composite panel onto a heating element, wherein the heating element includes a plurality of individually-controlled heat zones.

15. The method of claim 1, further comprising applying insulation on at least a portion of one of a front and a back surface of the thermoplastic composite panel.

16. The method of claim 1, wherein heating the thermoplastic panel is performed by one or more of the following: controlled infrared heating, torching or hot air blasts, and induction coils having varying amounts of magnetic field strength in different regions in contact with the thermoplastic composite panel.

17. The method of claim 1, wherein the thermoplastic composite panel comprises a reinforcement fiber and a thermoplastic matrix resin, wherein the thermoplastic matrix resin is one or more of: polyaryletherketone (PAEK), polyetherketoneketone (PEKK), polyetheretherketone (PEEK), polyphenylene sulfide (PPS), and Polyethylenimine (PEI).

18. The method of claim 1, wherein the thermoplastic composite panel is non-planar.

19. A method of thermoplastic composite processing, the method comprising:
compressing a thermoplastic composite panel, wherein the thermoplastic composite panel includes a plurality of terminal edges;
heating the thermoplastic composite panel to at least a melting temperature using at least one heat source to create a melt front of the thermoplastic composite panel at a first location; and
heating the thermoplastic composite panel to at least the melting temperature in a pre-determined pattern from the first location to extend the melt front toward the terminal edges of the thermoplastic composite panel to cause air constrained within the thermoplastic composite panel to escape the thermoplastic composite panel through unmelted portions of the thermoplastic composite panel located between the melt front and the terminal edges.

20. A method of thermoplastic composite processing, the method comprising:
compressing a thermoplastic composite panel, wherein the thermoplastic composite panel includes a plurality of terminal edges;
heating the thermoplastic composite panel to at least a melting temperature to create a melt front of the thermoplastic composite panel at a first location;
heating the thermoplastic composite panel to at least the melting temperature in a pre-determined pattern from the first location to extend the melt front toward the terminal edges of the thermoplastic composite panel to cause air constrained within the thermoplastic composite panel to escape the thermoplastic composite panel through unmelted portions of the thermoplastic composite panel located between the melt front and the terminal edges; and
cooling the thermoplastic composite panel to a temperature below the melting temperature after an entirety of the thermoplastic composite panel has been heated to at least the melting temperature.
